(19) United States
(12) Patent Application Publication
(10) Pub. No.: US 2005/0179556 A1
(43) Pub. Date: Aug. 18, 2005

(54) Alarm device for pickproofing a lock member

(75) Inventor: Hung-Cheng Tsai, Chia-Yi City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: EZ TREND TECHNOLOGY CO., LTD.

(21) Appl. No.: 10/779,735

(22) Filed: Feb. 18, 2004

(51) Int. Cl. G08B 21/00

(52) U.S. Cl. 340/686.1; 340/545.7

(57) ABSTRACT

An alarm device is used to pickproof a lock member, and includes a mounting member, an alarm actuator, and an alarm generator. The mounting member includes a base plate formed with a through hole. The alarm actuator is mounted removably in the through hole in the base plate. The alarm generator includes an alarm circuit, and a contact member connected electrically to the alarm circuit and disposed to contact the alarm actuator when the latter is mounted in the through hole. When operated in an armed mode, the alarm circuit generates an alarm output in response to detection by the contact member of removal of the alarm actuator from the base plate.

### BACKGROUND OF THE INVENTION

1. Field of the Invention

The invention relates to an alarm device, more particularly to an alarm device adapted for pickproofing a lock member.

2. Description of the Related Art

Various types of conventional locks are available to meet different requirements. For instance, a lock with a keyhole is designed for operation using a key, whereas a lock with a keypad is designed for operation by keying in a correct password. For added convenience, some locks employ more than one control mechanism. For example, vehicles, such as cars, motorcycles, etc., are generally equipped with a lock that can be manually operated with the use of a key, and that can be remotely operated with the use of a remote controller. In addition, the locks on doors of some premises can be controlled using either a key or electronic sensing equipment. Locks that can be operated through remote control or through electronic sensing equipment are also equipped with a key-operated mechanism so as to permit manual locking and unlocking operations in the event of failure of the remote controlled mechanism or electronic sensing mechanism.

Conventional key-operated lock mechanisms are disadvantageous in that a keyhole in the same is designed to be easily accessible and is thus susceptible to being picked by thieves. There is thus a need to enhance security of electronic locks that incorporate key-operated mechanisms.

### SUMMARY OF THE INVENTION

Therefore, the object of the present invention is to provide an alarm device for a lock member so as to overcome the aforesaid drawbacks associated with the prior art.

Accordingly, the alarm device of this invention is adapted for pickproofing a lock member that has one end formed with a keyhole. The alarm device comprises a mounting member, an alarm actuator, and an alarm generator. The mounting member includes a base plate formed with a through hole, and is adapted to be disposed adjacent to the lock member such that the through hole in the base plate is registered with the keyhole in the lock member. The mounting member is further formed with a containing space that opens toward the lock member. The alarm actuator is mounted removably in the through hole in the base plate. The alarm generator includes an alarm circuit disposed in the containing space, and a contact member connected electrically to the alarm circuit and disposed to contact the alarm actuator when the alarm actuator is mounted in the through hole in the base plate. The alarm circuit is operable in a selected one of an armed mode, where the alarm circuit generates an alarm output in response to detection by the contact member of removal of the alarm actuator from the through hole in the base plate, and a disarmed mode, where the alarm circuit is inhibited from generating the alarm output when the contact member detects the removal of the alarm actuator from the through hole in the base plate.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded, perspective view of the preferred embodiment of an alarm device for a lock member according to the present invention;

FIG. 2 is a partly exploded, schematic sectional view of the preferred embodiment;

FIG. 3 is an exploded perspective view to illustrate an alarm actuator of the preferred embodiment;

FIG. 4 is a partly exploded, partly sectional view of the alarm actuator of FIG. 3;

FIG. 5 is a partly sectional, schematic view to illustrate how the preferred embodiment can be used to deny access to a keyhole in a lock member;

FIG. 6 is a partly sectional view to illustrate an engaging position of retaining members of the alarm actuator;

FIG. 7 is a partly exploded, partly sectional view to illustrate how the alarm actuator is removed from a mounting member; and

FIG. 8 is a view similar to FIG. 6, but illustrating a disengaging position of the retaining members of the alarm actuator.

### DETAILED DESCRIPTION OF THE PREFERRED EMBODIMENT

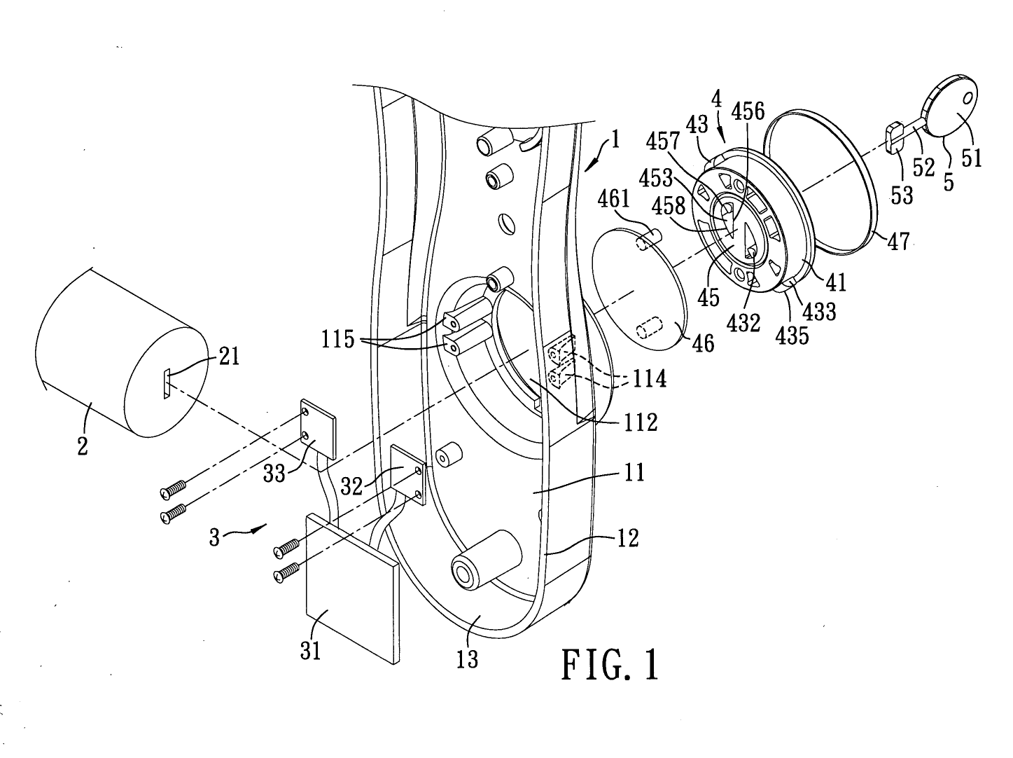

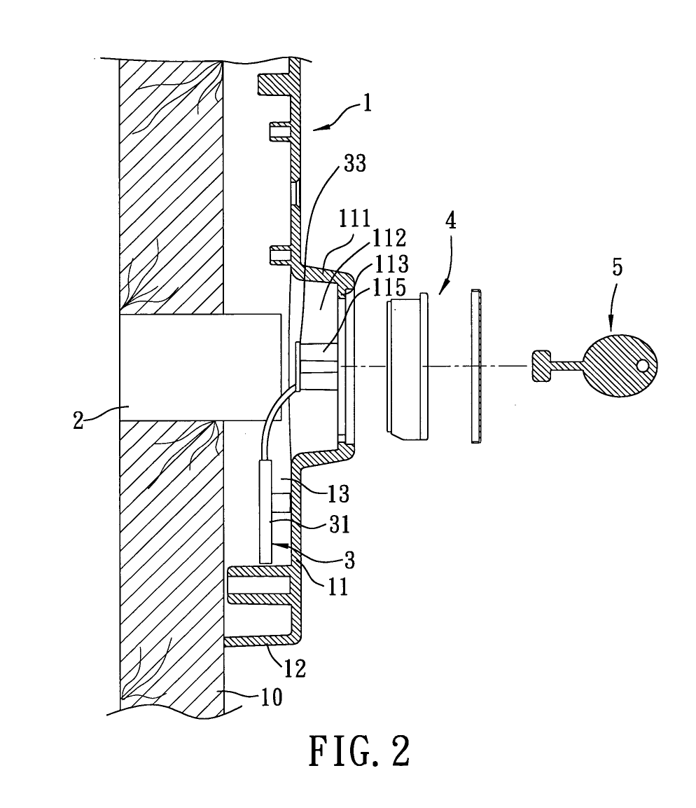

Referring to FIGS. 1 and 2, the preferred embodiment of an alarm device according to the present invention is shown to be adapted for pickproofing a conventional lock member 2 that has one end formed with a keyhole 21 and that is mounted on a door panel 10. The alarm device comprises a mounting member 1, an alarm actuator 4, and an alarm generator 3.

The mounting member 1 is to be mounted fixedly on the door panel 10, and includes a base plate 11 and a peripheral wall 12 that extends transversely from a periphery of the base plate 11 toward the door panel 10. The base plate 11 is formed with a through hole 112. The mounting member 1 is adapted to be disposed adjacent to the lock member 2 such that the through hole 112 in the base plate 11 is registered with the keyhole 21 in the lock member 2. The base plate 11 and the peripheral wall 12 cooperate to form the mounting member 1 with a containing space 13 that opens toward the lock member 2. In this embodiment, the base plate 11 is formed with a mounting tube 111 that defines the through hole 112 and that extends in a direction away from the lock member 2. The mounting tube 111 is formed with a radial inward flange 113 that extends into the through hole 112. The radial inward flange 113 has opposite outer and inner flange surfaces to be disposed distal from and proximate to the lock member 2, respectively.

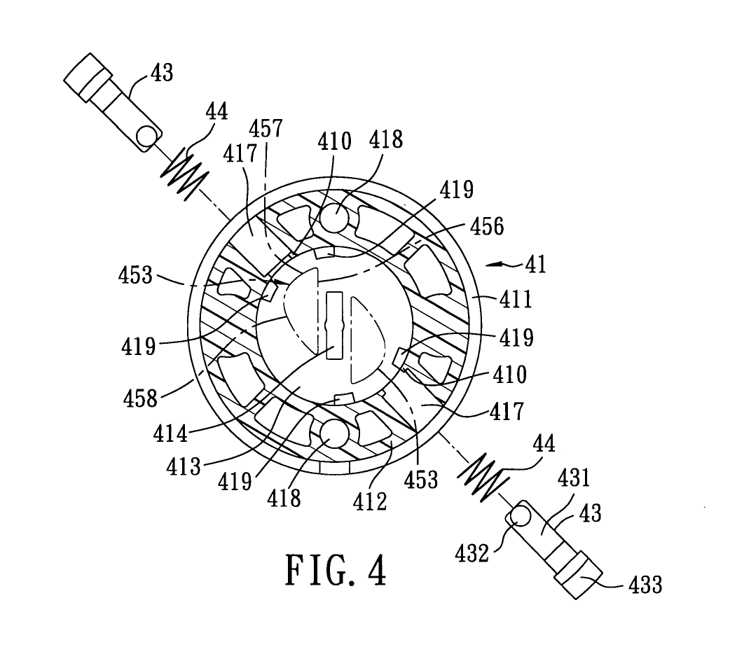

Referring to FIGS. 2, 3 and 4, the alarm actuator 4 is mounted removably in the through hole 112 in the base plate 11, and includes a base seat 41, a pair of magnets 42, a pair of retaining members 43, a pair of biasing members 44, a rotary member 45, an inner cap 46, an outer cap 47, and a release key 5. In this embodiment, the alarm actuator 4 is inserted removably into the mounting tube 111, and engages removably the radial inward flange 113 in the mounting tube 111.

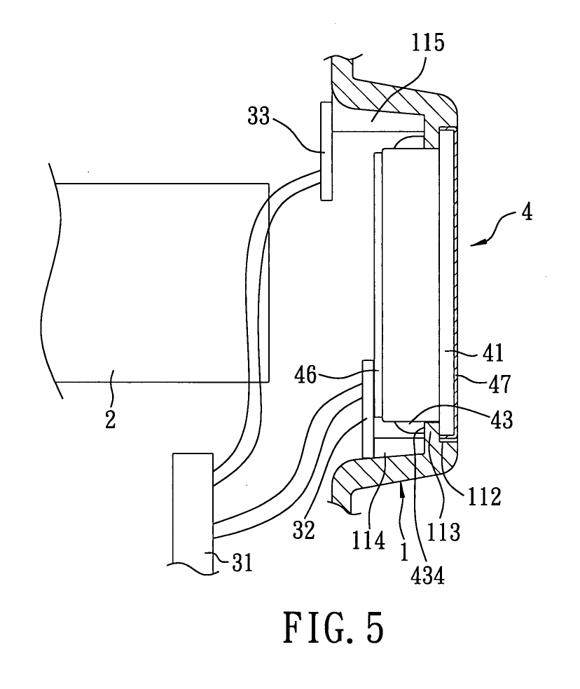

The base seat 41 has a face plate 411 and a retaining wall 412. The face plate 411 has a rim 416 that is disposed to abut against the outer flange surface of the radial inward flange 113 when the base seat 41 is inserted into the mounting tube 111, as best shown in FIG. 5. The retaining wall 412 extends from the face plate 411. The retaining wall 412 extends through the radial inward flange 113 and into the through hole 112 when the base seat 41 is inserted into the mounting tube 111, as best shown in FIG. 5. The retaining wall 412 confines a receiving space 413 that opens in a direction away from the face plate 411. The face plate 411 is further formed with an insert hole 414 therethrough, and has a pair of magnet recesses 415 for retaining the magnets 42 therein. The retaining wall 412 is formed with a pair of mounting holes 418, and a pair of diametrically opposite radial retaining holes 417 that are in spatial communication with the receiving space 413. The retaining wall 412 is further formed with two pairs of stop blocks 419 that project into the receiving space 413. The stop blocks 419 in each pair are disposed on two sides of a corresponding retaining hole 417. Each of the radial retaining holes 417 has a restricted opening 410 proximate to the receiving space 413.

Each of the retaining members 43 is received in a corresponding one of the retaining holes 417, and has opposite first and second end portions 433, 431. The first end portion 433 has an engaging surface 434 that is disposed proximate to the inner flange surface of the radial inward flange 113 when the base seat 41 is inserted into the mounting tube 111, and a curved surface 435 that is opposite to the engaging surface 434, and that abuts against the radial inward flange 113 and that permits movement of the retaining member 43 to a disengaging position when the retaining wall 412 is extended through the radial inward flange 113 during insertion of the base seat 41 into the mounting tube 111.

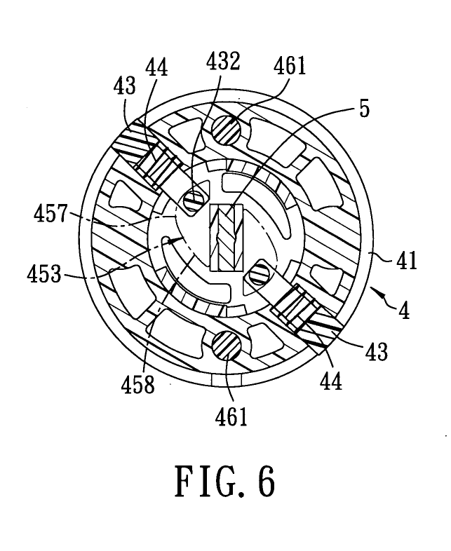

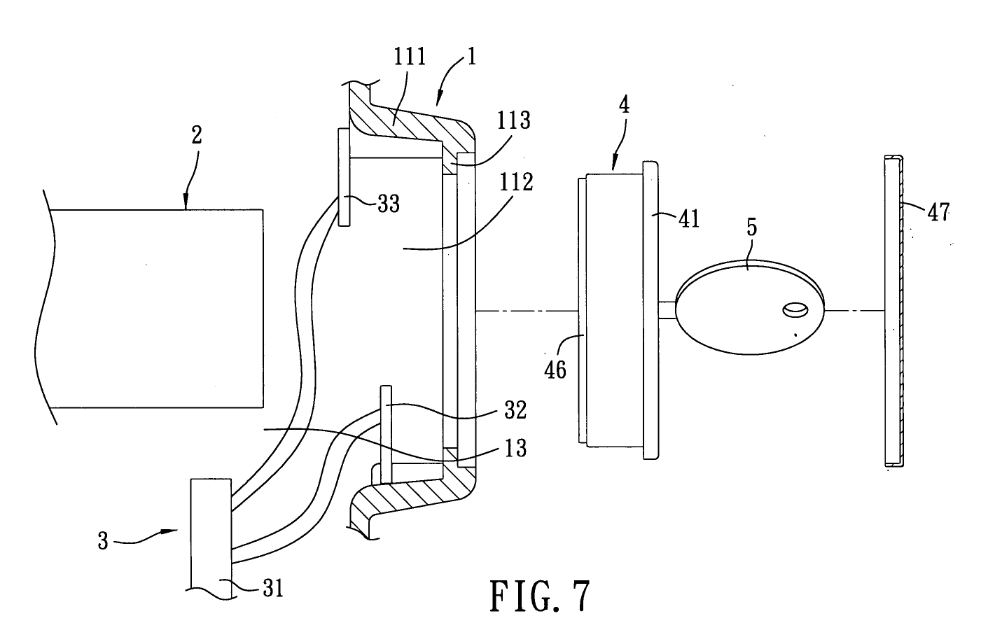

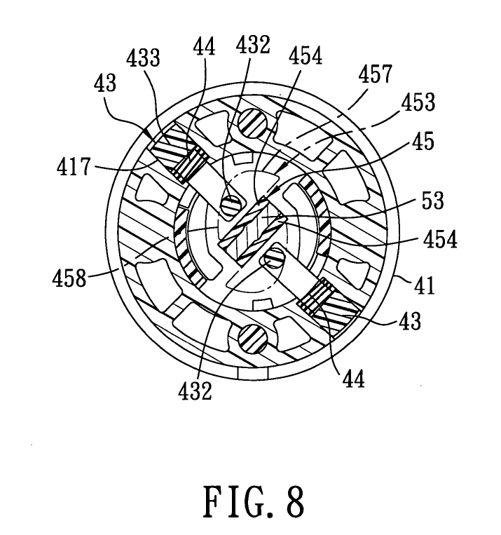

Each retaining member 43 is movable between an engaging position, where the engaging surface 434 of the first end portion 433 of the retaining member 43 abuts against the inner flange surface of the radial inward flange 113 such that the retaining member 43 and the face plate 411 cooperate to retain the base seat 41 in the mounting tube 111, as shown in FIGS. 5 and 6, and the disengaging position, where the retaining member 43 is retracted into the corresponding retaining hole 417 such that the first end portion 433 of the retaining member 43 disengages from the inner flange surface of the radial inward flange 113 so as to permit removal of the base seat 41 from the mounting tube 111, as shown in FIGS. 7 and 8. Each of the biasing members 44 serves to bias a corresponding one of the retaining members 43 to the engaging position.

The rotary member 45 is disposed rotatably in the receiving space 413, and is formed with a slot 455 to engage removably the release key 5. The rotary member 45 is coupled to the second end portions 431 of the retaining members 43 such that rotation of the rotary member 45 results in movement of the retaining members 43 between the engaging and disengaging positions.

The release key 5 includes an enlarged handle portion 51, a connecting stem 52 extending from the handle portion 51, and a control portion 53 connected to a distal end of the connecting stem 52. The release key 5 is to be inserted into the insert hole 414 in the face plate 411 of the base seat 41, engages removably the slot 455 in the rotary member 45, and is operable so as to drive rotation of the rotary member 45 relative to the base seat 41.

In this embodiment, the second end portions 431 of the retaining members 43 extend into the receiving space 413, and are disposed between the face plate 411 and the rotary member 45. The rotary member 45 includes a circular body 451 formed with a pair of cam surfaces 453 that act upon the second end portions 431 of the retaining members 43 such that rotation of the rotary member 45 due to operation of the release key 5 results in movement of the retaining members 43 between the engaging and disengaging positions. The circular body 451 is further formed with a pair of curved limit plates 452 that cooperate with the stop blocks 419 in the receiving space 413 to limit extent of angular rotation of the rotary member 45 relative to the base seat 41. Preferably, the slot 455 in the rotary member 45 is confined by a pair of slot-confining walls 454, which project from the circular body 451.

Each cam surface 453 of the rotary member 45 defines a corresponding cam hole, and includes a linear section 456 proximate to the center of the circular body 451 and having first and second end points, the first end point being disposed farther from the center of the circular body 451 than the second end point, a curved section 457 that extends counterclockwise from the first end point, and an inclined section 458 that extends from the second end point and that is connected to the curved section 457. The second end portion 431 of each retaining member 43 is formed with a cam post 432 that extends into the cam hole defined by the corresponding cam surface 453 and that abuts against the cam surface 453.

The inner cap 46 is formed with a pair of posts 461 that engage the mounting holes 418 in the retaining wall 412 so as to mount the inner cap 46 on the retaining wall 412, thereby closing the receiving space 413 and thereby retaining rotatably the rotary member 45 in the receiving space 413.

The outer cap 47 is mounted detachably on the base seat 41 to cover the insert hole 414. In this embodiment, the outer cap 47 is made of a magnetically attractive material, and is attracted to the base seat 41 by means of the magnets 42 disposed in the magnet recesses 415.

Referring once again to FIGS. 1 and 2, the alarm generator 3 includes an alarm circuit 31 disposed in the containing space 13, and a first contact member 32 connected electrically to the alarm circuit 31 and disposed to contact the alarm actuator 4 when the alarm actuator 4 is mounted in the through hole 112 in the base plate 11. The first contact member 32 is to be disposed between the base plate 11 and the lock member 2. The alarm generator 3 further includes a second contact member 33 connected electrically to the alarm circuit 31 and to be disposed closer to the lock member 2 than the first contact member 32. In this embodiment, the base plate 11 is further formed with a first post unit 114 that extends into the containing space 13 for mounting the first contact member 32 thereon, and a second post unit 115 that extends into the containing space 13 and that is longer than the first post unit 114 for mounting the second contact member 33 thereon.

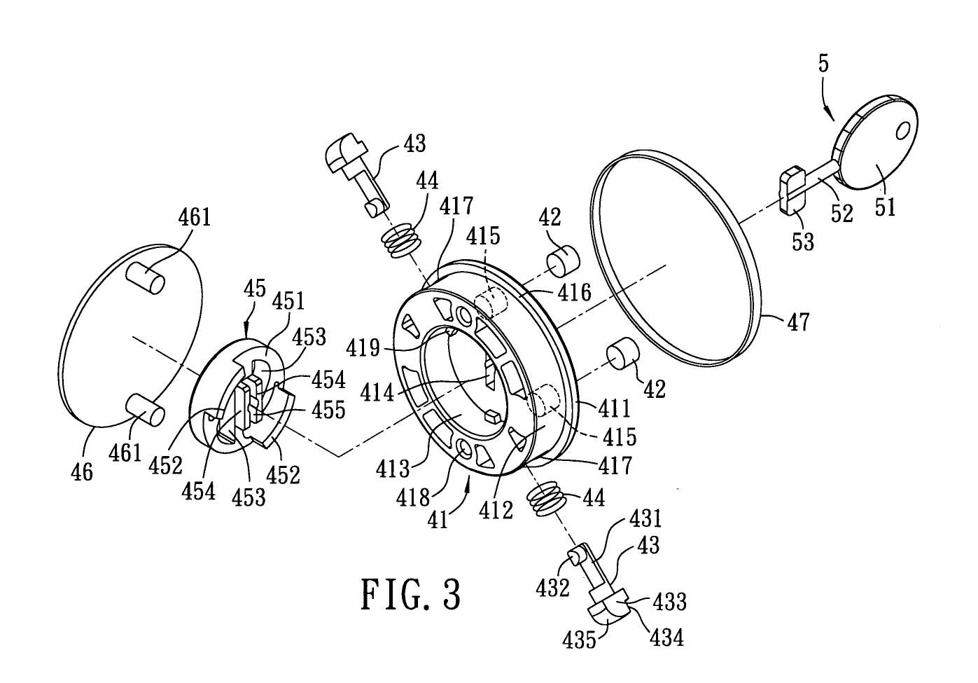

Referring to FIGS. 3, 5 and 6, when the retaining members 43 are in the engaging position and retain the alarm actuator 4 in the through hole 112 in the mounting member 1, the cam posts 432 abut against the curved sections 457 of the cam surfaces 453 such that the engaging surfaces 434 of the retaining members 43 abut against the inner flange surface of the radial inward flange 113. In addition, the inner cap 46 extends into the containing space 13 and abuts against the first contact member 32, and the outer cap 47 is attached to the base seat 41 to cover the insert hole 414. The alarm circuit 31 can be operated in an armed mode (such as with the use of a remote controller) at this time.

When the alarm actuator 4 is mounted in the through hole 112 in the mounting member 1, access to the keyhole 21 in the lock member 2 is not possible. When operated in the armed mode, the alarm circuit 31 generates an alarm output in response to detection by the first contact member 32 of removal of the alarm actuator 4 from the through hole 112 in the mounting member 1, thereby discouraging picking of the lock member 2.

Referring to FIGS. 3, 7 and 8, when it is desired to operate the lock member 2, it is necessary to first operate the alarm circuit 31 in a disarmed mode (such as with the use of the aforesaid remote controller). During operation in the disarmed mode, the alarm circuit 31 is inhibited from generating the alarm output when the first contact member 32 detects the removal of the alarm actuator 4 from the through hole 112 in the mounting member 1. While the alarm circuit 31 operates in the disarmed mode, the alarm actuator 4 can be removed from the mounting member 1 in the following manner: First, the outer cap 47 is detached from the base seat 41 to expose the insert hole 414. Then, the release key 5 is inserted into the insert hole 414 in the face plate 411 of the base seat 41, and engages the slot 455 in the rotary member 45. As the rotary member 45 rotates due to operation of the release key 5, the inclined sections 458 of the cam surfaces 453 will come into contact with the cam posts 432, thereby pulling the retaining members 43 to the disengaging position against biasing action of the biasing members 44. When the retaining members 43 are in the disengaging position, the alarm actuator 4 can be removed from the mounting member 1 with the use of the release key 5 so as to expose the keyhole 21 in the lock member 2. Thereafter, another key (not shown) can be inserted into the keyhole 21 through the through hole 112 in the mounting member 1 for operating the lock member 2.

To mount the alarm actuator 4 in the through hole 112, it is only required to push the former into the latter. As the retaining members 43 move into the through hole 112, the curved surfaces 435 thereof initiallyabut against the radial inward flange 113, thereby moving the retaining members 43 to the disengaging position. Subsequently, after the curved surfaces 435 have moved past the radial inward flange 113, the retaining members 43 are restored to the engaging position by virtue of the biasing members 44.

The alarm device of this invention is applicable to a battery-operated electric lock with a key-operated mechanism. While the electric lock has a relatively large electrical power requirement for driving locking and unlocking operations thereof, the electrical power required to arm and disarm the alarm circuit 31 is relatively small. Hence, while the residual power of a battery source may be inadequate for electrical operation of the electric lock, it is still sufficient to permit disarming of the alarm circuit 31.

As mentioned hereinabove, when operated in the armed mode, the alarm circuit 31 generates an alarm output in response to detection by the first contact member 32 of removal of the alarm actuator 4 from the through hole 112 in the mounting member 1, thereby discouraging picking of the lock member 2. On the other hand, if a burglar tries to break the alarm device of this invention, the alarm actuator 4 will be displaced toward the second contact member 33. Hence, during operation in the armed mode, the alarm circuit 31 further generates the alarm output when the second contact member 33 contacts the alarm actuator 4, thereby discouraging breaking of the alarm device of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. An alarm device adapted for pickproofing a lock member, the lock member having one end formed with a keyhole, said alarm device comprising:
a mounting member including a base plate formed with a through hole, said mounting member being adapted to be disposed adjacent to said one end of the lock member such that said through hole in said base plate is registered with the keyhole in the lock member, said mounting member being formed with a containing space that opens toward said one end of the lock member;
an alarm actuator mounted removably in said through hole in said base plate; and
an alarm generator including an alarm circuit disposed in said containing space, and a first contact member connected electrically to said alarm circuit and disposed to contact said alarm actuator when said alarm actuator is mounted in said through hole in said base plate;
said alarm circuit being operable in a selected one of an armed mode, where said alarm circuit generates an alarm output in response to detection by said first contact member of removal of said alarm actuator from said through hole in said base plate, and a disarmed mode, where said alarm circuit is inhibited from generating the alarm output when said first contact member detects the removal of said alarm actuator from said through hole in said base plate.

2. The alarm device as claimed in claim 1, wherein said first contact member is to be disposed between said base plate and said one end of the lock member,
said alarm generator further including a second contact member connected electrically to said alarm circuit and to be disposed closer to said one end of the lock member than said first contact member,
said alarm circuit generating the alarm output when said second contact member contacts said alarm actuator while said alarm circuit operates in the armed mode.

3. The alarm device as claimed in claim 2, wherein said base plate is formed with a first post unit that extends into said containing space for mounting said first contact member thereon, and a second post unit that extends into said containing space and that is longer than said first post unit for mounting said second contact member thereon.

4. The alarm device as claimed in claim 1, wherein said base plate is formed with a mounting tube that defines said through hole, said mounting member being adapted to be disposed adjacent to said one end of the lock member such that said mounting tube extends in a direction away from said one end of the lock member,
said mounting tube being formed with a radial inward flange that extends into said through hole, said alarm actuator being inserted removably into said mounting tube and engaging removably said radial inward flange in said mounting tube.

5. The alarm device as claimed in claim 4, wherein said radial inward flange has opposite outer and inner flange surfaces to be disposed distal from and proximate to said one end of the lock member, respectively,
said alarm actuator including:
a base seat having a face plate with a rim that is disposed to abut against said outer flange surface of said radial inward flange when said base seat is inserted into said mounting tube, said base seat further having a retaining wall that extends from said face plate, said retaining wall extending through said radial inward flange and into said through hole when said base seat is inserted into said mounting tube, said face plate being formed with an insert hole therethrough, said retaining wall being formed with a radial retaining hole therethrough;
a retaining member received in said retaining hole and having opposite first and second end portions, said retaining member being movable between an engaging position, where said first end portion of said retaining member abuts against said inner flange surface of said radial inward flange such that said retaining member and said face plate cooperate to retain said base seat in said mounting tube, and a disengaging position, where said retaining member is retracted into said retaining hole such that said first end portion of said retaining member disengages from said inner flange surface of said radial inward flange so as to permit removal of said base seat from said mounting tube;
a biasing member for biasing said retaining member to the engaging position;
a rotary member coupled to said second end portion of said retaining member such that rotation of said rotary member results in movement of said retaining member between the engaging and disengaging positions; and
a release key that is inserted into said insert hole in said face plate of said base seat, that engages removably said rotary member, and that is operable so as to drive rotation of said rotary member relative to said base seat.

6. The alarm device as claimed in claim 5, wherein said retaining wall of said base seat confines a receiving space that opens in a direction away from said face plate, said rotary member being disposed rotatably in said receiving space and being formed with a slot to engage removably said release key.

7. The alarm device as claimed in claim 6, wherein said second end portion of said retaining member extends into said receiving space and is disposed between said face plate and said rotary member, said rotary member being formed with a cam surface that acts upon said second end portion of said retaining member such that rotation of said rotary member due to operation of said release key results in movement of said retaining member between the engaging and disengaging positions.

8. The alarm device as claimed in claim 7, wherein said cam surface of said rotary member defines a cam hole, said second end portion of said retaining member being formed with a cam post that extends into said cam hole and that abuts against said cam surface.

9. The alarm device as claimed in claim 5, wherein said first end portion of said retaining member has a curved surface that abuts against said radial inward flange and that permits movement of said retaining member to the disengaging position when said retaining wall is extended through said radial inward flange during insertion of said base seat into said mounting tube.

10. The alarm device as claimed in claim 5, wherein said alarm actuator further includes an outer cap mounted detachably on said base seat to cover said insert hole.

11. The alarm device as claimed in claim 10, wherein said outer cap is made of a magnetically attractive material, said face plate being formed with a magnet recess, said alarm actuator further including a magnet disposed in said magnet recess for attracting said outer cap to said base seat so as to mount detachably said outer cap on said base seat.

12. The alarm device as claimed in claim 6, wherein said alarm actuator further includes an inner cap mounted on said retaining wall so as to close said receiving space and so as to retain rotatably said rotary member in said receiving space.
